(19) United States
(12) Patent Application Publication
(10) Pub. No.: US 2025/0212202 A1
(43) Pub. Date: Jun. 26, 2025

(54) METHOD AND DEVICE FOR REPORTING CODEWORD TO LAYER MAPPING, METHOD AND DEVICE FOR RECEIVING CODEWORD TO LAYER MAPPING, AND MEDIUM

(71) Applicant: Beijing Xiaomi Mobile Software Co., Ltd., Beijing (CN)

(72) Inventor: Xueyuan GAO, Beijing (CN)

(73) Assignee: Beijing Xiaomi Mobile Software Co., Ltd., Beijing (CN)

(21) Appl. No.: 18/852,315

(22) PCT Filed: Mar. 30, 2022
(86) PCT No.: PCT/CN2022/084000

§ 371 Date: Sep. 27, 2024

(51) Int. Cl. H04W 72/1263; H04L 5/00; H04W 24/10; H04W 72/51; H04W 72/54

(52) U.S. Cl. CPC H04W 72/1263; H04L 5/0044; H04W 24/10; H04W 72/51; H04W 72/54

(57) ABSTRACT

A method, device and computer readable medium for reporting codeword-to-layer mapping. The reporting codeword-to-layer mapping is performed by: reporting capability information of the terminal, where the capability information is configured to determine support for enabling a type 2 layer mapping scheme; where a maximum difference in a number of transmission layers after two codewords are subjected to layer mapping is different respectively for a type 1 mapping scheme and the type 2 layer mapping scheme.

### CROSS-REFERENCE TO RELATED APPLICATIONS

The present application is a U.S. National Stage of International Application No. PCT/CN2022/084000, filed on Mar. 30, 2022, the contents of all of which are incorporated herein by reference in their entirety for all purposes.

### BACKGROUND OF THE INVENTION

As a wireless communication system, a multi-input multi-output (MIMO) system transmits data by means of multiple transmitting antennas and multiple receiving antennas.

### SUMMARY OF THE INVENTION

The present disclosure relates to the field of wireless communication, and particularly relates to a method and device for reporting codeword-to-layer mapping, a method and device for receiving codeword-to-layer mapping, a device, and a medium. A method and device for reporting codeword-to-layer mapping, a method and device for receiving codeword-to-layer mapping, a device, and a medium are provided according to embodiments of the present disclosure. The technical solutions are as follows.

According to an aspect of an embodiment of the present disclosure, a method for reporting codeword-to-layer mapping is provided. The method is performed by a terminal and includes:
reporting capability information of the terminal, where the capability information is configured to determine support for enabling a type 2 layer mapping scheme; where a maximum difference in a number of transmission layers after two codewords are subjected to layer mapping is different respectively for a type 1 mapping scheme and the type 2 layer mapping scheme.

According to another aspect of an embodiment of the present disclosure, a method for receiving codeword-to-layer mapping is provided. The method is performed by a network device and includes:
receiving capability information of a terminal, where the capability information is configured to determine support for enabling a type 2 layer mapping scheme; where a maximum difference in a number of transmission layers after two codewords are subjected to layer mapping is different respectively for a type 1 mapping scheme and the type 2 layer mapping scheme.

According to another aspect of an embodiment of the present disclosure, a terminal is provided. The terminal includes a processor and a memory that stores a computer program. The processor executes the computer program to cause the terminal to report capability information of the terminal, where the capability information is configured to determine support for enabling a type 2 layer mapping scheme, where a maximum difference in a number of transmission layers after two codewords are subjected to layer mapping is different respectively for a type 1 mapping scheme and the type 2 layer mapping scheme.

According to another aspect of an embodiment of the present disclosure, a network device is provided. The network device includes a processor and a memory that stores a computer program. The processor executes the computer program to cause the network device to perform the method for receiving codeword-to-layer mapping above.

### BRIEF DESCRIPTION OF DRAWINGS

In order to describe technical solutions in embodiments of the present disclosure more clearly, accompanying drawings required to be used in descriptions of the embodiments will be briefly provided below. Apparently, the accompanying drawings in the following descriptions illustrate merely some embodiments of the present disclosure. Those of ordinary skill in the art can also obtain other accompanying drawings according to these accompanying drawings without creative efforts.

FIG. 1 is a block diagram of a communication system according to an example of the present disclosure;

FIG. 2 is a flowchart of a method for reporting codeword-to-layer mapping according to an example of the present disclosure;

FIG. 3 is a schematic diagram of mapping between codewords and transmission layers according to an example of the present disclosure;

FIG. 4 is a schematic diagram of mapping between codewords and transmission layers according to another example of the present disclosure;

FIG. 5 is a schematic diagram of mapping between codewords and transmission layers according to another example of the present disclosure;

FIG. 6 is a schematic diagram of mapping between codewords and transmission layers according to another example of the present disclosure;

FIG. 7 is a flowchart of a method for reporting codeword-to-layer mapping according to an example of the present disclosure;

FIG. 8 is a flowchart of a method for reporting codeword-to-layer mapping according to an example of the present disclosure;

FIG. 9 is a flowchart of a method for reporting codeword-to-layer mapping according to an example of the present disclosure;

FIG. 10 is a flowchart of a method for reporting codeword-to-layer mapping according to an example of the present disclosure;

FIG. 11 is a flowchart of a method for reporting codeword-to-layer mapping according to an example of the present disclosure;

FIG. 12 is a flowchart of a method for receiving codeword-to-layer mapping according to an example of the present disclosure;

FIG. 13 is a flowchart of a method for receiving codeword-to-layer mapping according to an example of the present disclosure;

FIG. 14 is a flowchart of a method for receiving codeword-to-layer mapping according to an example of the present disclosure;

FIG. 15 is a flowchart of a method for receiving codeword-to-layer mapping according to an example of the present disclosure;

FIG. 16 is a flowchart of a method for reporting codeword-to-layer mapping according to an example of the present disclosure;

FIG. 17 is a block diagram of a device for reporting codeword-to-layer mapping according to an example of the present disclosure;

FIG. 18 is a block diagram of a device for receiving codeword-to-layer mapping according to an example of the present disclosure; and

FIG. 19 is a schematic structural diagram of a communication device according to an example of the present disclosure.

### DETAILED DESCRIPTION OF THE INVENTION

In order to make the objectives, technical solutions and advantages of the present disclosure clearer, embodiments of the present disclosure will be further described in detail below in combination with accompanying drawings.

When the following description relates to the accompanying drawings, the same numbers in different accompanying drawings refer to the same or similar elements unless otherwise indicated. The embodiments described in the following examples do not represent all embodiments consistent with the embodiments of the present disclosure. Rather, they are merely instances of devices and methods consistent with some aspects of the appended claims of the present disclosure.

Terms used in the embodiments of the present disclosure is for the purpose of describing particular embodiments merely and are not intended to limit the embodiments of the present disclosure. As used in the embodiments of the present disclosure, singular forms “a,” “an” and “the/said” are intended to include plural forms as well, unless otherwise indicated in the context clearly. It should be understood that the term “and/or” as used here refers to and encompasses any or all possible combinations of at least one of associated listed items.

It should be understood that although the terms of “first,” “second,” “third” and the like may be used in the embodiments of the present disclosure to describe various information, such information should not be limited to these terms. These terms are merely used to distinguish the same type of information from each other. For example, first information may also be referred to as second information, and similarly, second information may also be referred to as first information, without departing from the scope of the embodiments of the present disclosure. The word “if” as used here may be construed to mean “at the time of,” or “when,” or “in response to determining,” depending on the context.

For purposes of concision and ease of understanding, the term “greater than” or “less than” are used here to represent size relations. Those skilled in that art can understand that the term “greater than” also encompasses the meaning of “greater than or equal to,” and the term “less than” also encompasses the meaning of “less than or equal to”.

A network architecture and a service scenario described in embodiments of the present disclosure are used to more clearly explain the technical solutions of the embodiments of the present disclosure, which do not limit the technical solutions provided in the embodiments of the present disclosure. One ordinary skill in the art can understand that the technical solutions provided in the embodiments of the present disclosure are also applicable to similar technical problems as network architectures evolve and new service scenarios appear.

As a wireless communication system, the MIMO system transmits data by means of multiple transmitting antennas and multiple receiving antennas.

During the data transmission process between a terminal and a network device, due to the mismatch between the number of codewords and the number of transmitting antennas, it is necessary to map the codewords to different transmission layers according to certain rules. A fixed mapping order of transport blocks to codewords is usually adopted, and the codeword-to-layer mapping is implemented in as balanced a manner as possible, i.e., the number of transmission layers corresponding to different codewords is either the same or differs by one layer.

However, how the network device can understand the capability of the terminal to support the codeword-to-layer mapping schemes remains an urgent problem to be resolved.

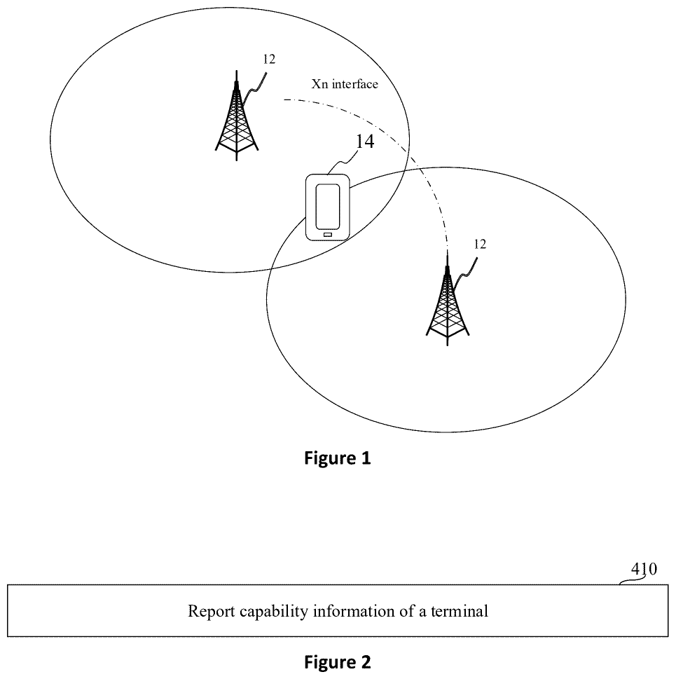

FIG. 1 illustrates a block diagram of a communication system according to an example of the present disclosure. The communication system may include a network device 12 and a terminal 14.

The network device 12 may be a base station. The base station is a device deployed in an access network to provide a wireless communication function to the terminal. The base station may include various forms of macro base stations, micro base stations, relay stations, access points, etc. In systems employing different radio access technologies, names of devices having base station functions may be different. For instance, the device is referred to as evolved node B (eNodeB or eNB) in a long term evolution (LTE) system, and is also referred to as next generation evolved node B (gNodeB or gNB) in a 5G new radio unlicense (5G NR-U) system. The description of “base station” may change as communication technologies evolve. For convenience, in embodiments of the present disclosure, the above devices for providing the wireless communication function for the terminal 14 are collectively referred to as network devices. Optionally, a communication interface between network devices 12 is an Xn interface.

The terminal 14 may include various handheld devices, vehicle-mounted devices, wearable devices, computing devices or other processing devices connected to a wireless modem, which have wireless communication functions, as well as various forms of user equipment (UE), mobile stations (MS), terminal devices, etc. For convenience of description, the above devices are collectively referred to as terminals. The network device 12 and the terminal 14 are in communication with each other by means of an air interface technology, such as a Uu interface. Optionally, the terminal 14 supports performing a small data transmission process in an inactive state.

The technical solutions of embodiments of the present disclosure may be applied to various communication systems, such as a global system of mobile communication (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolved system of the NR system, an LTE-based access to unlicensed spectrum (LTE-U) system, an NR-U system, a universal mobile telecommunication system (UMTS), a worldwide interoperability for microwave access (WiMAX) communication system, wireless local area networks (WLAN), wireless fidelity (WiFi), a next-generation communication system, or other communication systems.

Generally, traditional communication systems support a limited number of connections easy to implement. However, as communication technologies develop, mobile communication systems will support not only traditional communication, but also device to device (D2D) communication, machine to machine (M2M) communication, machine type communication (MTC), vehicle to vehicle (V2V) communication, and vehicle to everything (V2X) system, etc. Embodiments of the present disclosure may also be applied to these communication systems.

FIG. 2 provides a flowchart of a method for reporting codeword-to-layer mapping according to an example of the present disclosure. A terminal in the method may be performed by the terminal shown in FIG. 1. The method includes as follows.

Step 410: Capability information of the terminal is reported.

For instance, the capability information is configured to determine support for enabling a type 2 layer mapping scheme. For instance, the capability information may indicate the support for enabling a type 2 layer mapping scheme for terminal transmission, and may also indicate the support for enabling a type 2 layer mapping scheme for different layer transmission of the terminal. The description dimension of the capability information is not limited in the present disclosure.

Correspondingly, the capability information of the terminal is received by the network device.

For instance, in an uplink or a downlink, a target layer mapping scheme is determined, enabled, activated or supported. In other words, in the uplink, a type 1 layer mapping scheme or a type 2 layer mapping scheme is determined and enabled by the terminal. In the downlink, a type 1 layer mapping scheme or a type 2 layer mapping scheme is determined and enabled by the network device. In an example, an uplink scenario is provided for illustration in an embodiment of the present disclosure.

The type 1 layer mapping scheme refers to a scheme in which codewords are mapped to one or more transmission layers.

The type 2 layer mapping scheme refers to another scheme in which codewords are mapped to one or more transmission layers.

It can be understood that the type 1 layer mapping scheme and the type 2 layer mapping scheme indicate different layer mapping schemes. The names of layer mapping schemes are not specifically limited in an example of the present disclosure.

The codeword refers to data derived from the same information bit block and subjected to channel coding.

The layer mapping refers to a mechanism for assigning codewords to specified transmission layers, and may also be referred to as “codeword-to-layer mapping” or “codeword-layer mapping”.

It can be understood that the layer mapping may be a “codeword-to-layer mapping” process of an uplink determined by the terminal, or a “codeword-to-layer mapping” process of a downlink determined by the network device, which is not limited in the embodiment of the present disclosure.

The maximum difference in the number of transmission layers after two codewords are subjected to layer mapping is different respectively for the type 1 mapping scheme and the type 2 layer mapping scheme. For instance, the number of transmission layers are not limited in the type 1 layer mapping scheme and the type 2 layer mapping scheme. Only the maximum values of differences in the number of transmission layers after two codewords are subjected to layer mapping for are different.

For instance, the type 1 layer mapping scheme and the type 2 layer mapping scheme may be applied to a transmission scenario of uplink codewords, and may also be applied to a transmission scenario of downlink codewords. The instance where these schemes are applied to the uplink codewords scenario is provided for illustration in the embodiment of the present disclosure.

According to the method provided in the embodiment, it enables the network device to understand the capability of the terminal to support the enablement of the type 2 layer mapping scheme by having the terminal report its capability information to the network device. The type 2 layer mapping scheme can allow flexible configuration of the number of transmission layers after mapping two codewords to layers, which can, in turn, meet the transmission requirements of different scenarios through this flexible configuration of transmission layers.

The layer mapping schemes are illustratively provided below.

### A Type 1 Layer Mapping Scheme:

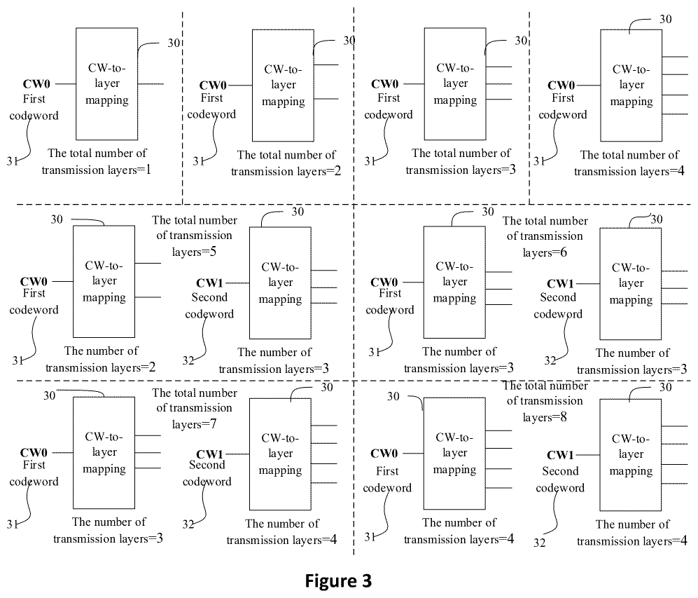

For example, the maximum value of the total number of transmission layers is 8 (layers), as shown in FIG. 3, the type 1 layer mapping scheme includes 8 layer mapping schemes corresponding to one codeword and two codewords. In the type 1 layer mapping scheme, the number of transmission layers corresponding to one codeword subjected to the layer mapping is greater than 0 and less than or equal to 4. Two codewords includes a first codeword 31 and a second codeword 32, where a first number of transmission layers corresponds to the first codeword 31 subjected to the layer mapping, and a second number of transmission layers corresponds to the second codeword 32 subjected to the layer mapping. The layer mapping may be CW-to-layer mapping 30 as shown in FIG. 3. In the type 1 layer mapping scheme, a difference in the number of transmission layers between the first number of transmission layers and second number of transmission layers is 0 or 1, and the sum of the first number of transmission layers and second number of transmission layers is greater than 4 and less than or equal to 8. For instance, a type 1 layer mapping scheme corresponding to one codeword (including CW0, e.g., the first codeword 31) includes four schemes as follows:
CW0 is mapped to one transmission layer, for instance, CW0 is mapped to transmission layer 1, and the total number of transmission layers is 1;
CW0 is mapped to two transmission layers, for instance, CW0 is mapped to transmission layer 1 and transmission layer 2, and the total number of transmission layers is 2;
CW0 is mapped to three transmission layers, for instance, CW0 is mapped to transmission layer 1 to transmission layer 3, and the total number of transmission layers is 3; and
CW0 is mapped to four transmission layers, for instance, CW0 is mapped to transmission layer 1 to transmission layer 4, and the total number of transmission layers is 4.

A type 1 layer mapping scheme corresponding to two codewords (including CW0 and CW1, e.g., the first codeword 31 corresponds to CW0 and the second codeword 32 corresponds to CW1, as shown in FIG. 3) includes four schemes as follows:
CW0 is mapped to two transmission layers and CW1 is mapped to three transmission layers, for instance, CW0 is mapped to transmission layer 1 and transmission layer 2, CW1 is mapped to transmission layer 3 to transmission layer 5, where the total number of transmission layers is 5;
CW0 is mapped to three transmission layers and CW1 is mapped to three transmission layers, for instance, CW0 is mapped to transmission layer 1 to transmission layer 3, and CW1 is mapped to transmission layer 4 to transmission layer 6, where the total number of transmission layers is 6;
CW0 is mapped to three transmission layers and CW1 is mapped to four transmission layers, for instance, CW0 is mapped to transmission layer 1 to transmission layer 3, CW1 is mapped to transmission layer 4 to transmission layer 7, where the total number of transmission layers is 7; and
CW0 is mapped to four transmission layers and CW1 is mapped to four transmission layers, for instance, CW0 is mapped to transmission layer 1 to transmission layer 4, CW1 is mapped to transmission layer 5 to transmission layer 8, where the total number of transmission layers is 8.

### A Type 2 Layer Mapping Scheme:

For example, the maximum value of the total number of transmission layers is 8 (layers), as shown in FIG. 4, the type 2 layer mapping scheme includes 16 layer mapping schemes corresponding to one codeword and two codewords. In the type 2 layer mapping scheme, the number of transmission layers corresponding to one codeword subjected to the layer mapping is greater than 0 and less than or equal to 4.

For instance, as shown in FIG. 4, a type 2 layer mapping scheme corresponding to one codeword (including CW0) includes four schemes as follows:
CW0 is mapped to one transmission layer, for instance, CW0 is mapped to transmission layer 1, and the total number of transmission layers is 1;
CW0 is mapped to two transmission layers, for instance, CW0 is mapped to transmission layer 1 and transmission layer 2, and the total number of transmission layers is 2;
CW0 is mapped to three transmission layers, for instance, CW0 is mapped to transmission layer 1 to transmission layer 3, and the total number of transmission layers is 3; and
CW0 is mapped to four transmission layers, for instance, CW0 is mapped to transmission layer 1 to transmission layer 4, and the total number of transmission layers is 4.

The two codewords include a first codeword 31 and a second codeword 32, where a first number of transmission layers corresponds to the first codeword 31 subjected to the layer mapping, and a second number of transmission layers corresponds to the second codeword 32 subjected to the layer mapping. The layer mapping may be CW-to-layer mapping 30 as shown in FIG. 4. In the type 2 layer mapping scheme, the maximum difference in the number of transmission layers between the first number of transmission layers and second number of transmission layers is allowed to be greater than 1, and the sum of the first number of transmission layers and the second number of transmission layers is greater than 1 and less than or equal to 8.

It can be known from the above description of the type 1 layer mapping scheme, the difference between the first number of transmission layers and the second number of transmission layers using the type 1 layer mapping scheme is zero or one, while the maximum difference in the number of transmission layers between the first number of transmission layers and the second number of transmission layers using the type 2 layer mapping scheme is allowed to be greater than 1. This enables the type 2 layer mapping scheme to be more flexible than the type 1 layer mapping scheme. In a case where the maximum value of the total number of transmission layers is 8, the difference in the number of transmission layers between the first number of transmission layers and the second number of transmission layers using the type 2 layer mapping scheme may be any integer from zero to six. For instance, CW0 is mapped to transmission layer 1, CW1 is mapped to transmission layer 2 to 8, the total number of transmission layers is 8, and the difference in the number of transmission layers between the first number of transmission layers and the second number of transmission layers is 6.

Optionally, the type 2 layer mapping scheme includes at least one of:
supporting the transmission of two codewords over five to eight transmission layers;
supporting the transmission of two codewords over four or more transmission layers (including four layers); or
supporting the transmission of two codewords over two or more transmission layers.

The scheme supports the transmission of two codewords over five to eight transmission layers in the type 2 layer mapping scheme:

As shown in FIG. 4, in a case where the type 2 layer mapping scheme supports the transmission of two codewords over five to eight transmission layers, the type 2 layer mapping scheme corresponding to two codewords (including CW0 and CW1, e.g., the first codeword 31 corresponds to CW0 and the second codeword 32 corresponds to CW1, as shown in FIG. 4) includes 12 schemes as follows:
CW0 is mapped to one transmission layer and CW1 is mapped to four transmission layers, for instance, CW0 is mapped to transmission layer 1, CW1 is mapped to transmission layer 2 to transmission layer 5, where the total number of transmission layers is 5;
CW0 is mapped to two transmission layers and CW1 is mapped to three transmission layers, for instance, CW0 is mapped to transmission layer 1 and transmission layer 2, CW1 is mapped to transmission layers 3 to 5, where the total number of transmission layers is 5;
CW0 is mapped to one transmission layer and CW1 is mapped to five transmission layers, for instance, CW0 is mapped to transmission layer 1, CW1 is mapped to transmission layer 2 to transmission layer 6, where the total number of transmission layers is 6;
CW0 is mapped to two transmission layers and CW1 is mapped to four transmission layers, for instance, CW0 is mapped to transmission layer 1 and transmission layer 2, CW1 is mapped to transmission layer 3 to transmission layer 6, where the total number of transmission layers is 6;
CW0 is mapped to three transmission layers and CW1 is mapped to three transmission layers, for instance, CW0 is mapped to transmission layer 1 to transmission layer 3, CW1 is mapped to transmission layer 4 to transmission layer 6, where the total number of transmission layers is 6;
CW0 is mapped to one transmission layer, and CW1 is mapped to six transmission layers, for instance, CW0 is mapped to transmission layer 1, CW1 is mapped to transmission layer 2 to transmission layer 7, where the total number of transmission layers is 7;
CW0 is mapped to two transmission layers and CW1 is mapped to five transmission layers, for instance, CW0 is mapped to transmission layer 1 and transmission layer 2, CW1 is mapped to transmission layer 3 to transmission layer 7, where the total number of transmission layers is 7;
CW0 is mapped to three transmission layers and CW1 is mapped to four transmission layers, for instance, CW0 is mapped to transmission layer 1 to transmission layer 3, CW1 is mapped to transmission layer 4 to transmission layer 7, where the total number of transmission layers is 7;
CW0 is mapped to one transmission layer, and CW1 is mapped to seven transmission layers, for instance, CW0 is mapped to transmission layer 1, CW1 is mapped to transmission layers 2 to 8, where the total number of transmission layers is 8;
CW0 is mapped to two transmission layers, and CW1 is mapped to six transmission layers, for instance, CW0 is mapped to transmission layer 1 and transmission layer 2, CW1 is mapped to transmission layer 3 to transmission layer 8, where the total number of transmission layers is 8;
CW0 is mapped to three transmission layers and CW1 is mapped to five transmission layers, for instance, CW0 is mapped to transmission layer 1 to transmission layer 3, CW1 is mapped to transmission layer 4 to transmission layer 8, where the total number of transmission layers is 8; and
CW0 is mapped to four transmission layers, and CW1 is mapped to four transmission layers, for instance, CW0 is mapped to transmission layer 1 to transmission layer 4, CW1 is mapped to transmission layer 5 to transmission layer 8, where the total number of transmission layers is 8.

The scheme supports the transmission of two codewords over four or more layers (including 4 layers) in the type 2 layer mapping scheme:

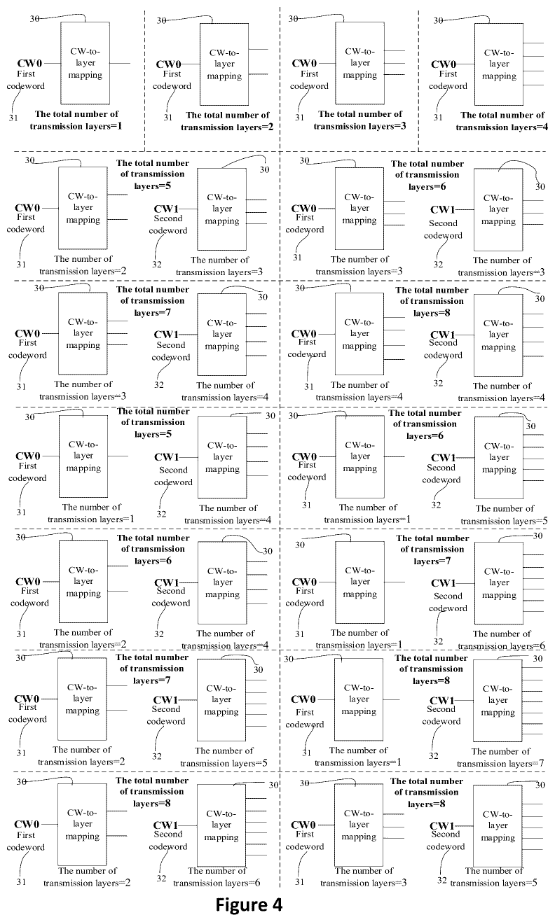

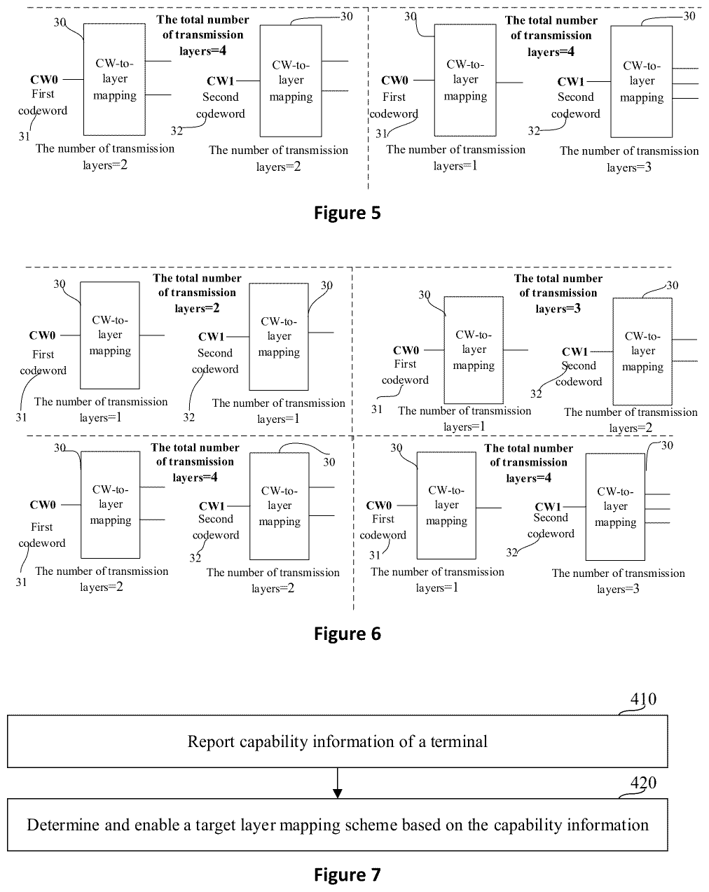

As shown in FIG. 5, in a case where the type 2 layer mapping scheme supports the transmission of two codewords over four or more layers (including 4 layers), the type 2 layer mapping scheme corresponding to two codewords (including CW0 and CW1, e.g., the first codeword 31 corresponds to CW0 and the second codeword 32 corresponds to CW1, as shown in FIG. 5) further includes, based on FIG. 4, two schemes as follows:
CW0 is mapped to one transmission layer and CW1 is mapped to three transmission layers, for instance, CW0 is mapped to transmission layer 1, CW1 is mapped to transmission layer 2 to transmission layer 4, where the total number of transmission layers is 4; and
CW0 is mapped to two transmission layers and CW1 is mapped to two transmission layers, for instance, CW0 is mapped to transmission layer 1 and transmission layer 2, CW1 is mapped to transmission layer 3 and transmission layer 4, where the total number of transmission layers is 4. The layer mapping may be CW-to-layer mapping 30 as shown in FIG. 5.

The scheme supports the transmission of two codewords over two or more layers in the type 2 layer mapping scheme:

As shown in FIG. 6, in a case where the type 2 layer mapping scheme supports the transmission of two codewords over two or more layers, the type 2 layer mapping scheme corresponding to two codewords (including CW0 and CW1, e.g., the first codeword 31 corresponds to CW0 and the second codeword 32 corresponds to CW1, as shown in FIG. 6) furthers include, based on FIG. 4, 4 schemes as follows:
CW0 is mapped to one transmission layer and CW1 is mapped to one transmission layer, for instance, CW0 is mapped to transmission layer 1, CW1 is mapped to transmission layer 2, where the total number of transmission layers is 2;
CW0 is mapped to one transmission layer, and CW1 is mapped to two transmission layers, for instance, CW0 is mapped to transmission layer 1, CW1 is mapped to transmission layer 2 and transmission layer 3, where the total number of transmission layers is 3;
CW0 is mapped to one transmission layer, and CW1 is mapped to three transmission layers, for instance, CW0 is mapped to transmission layer 1, CW1 is mapped to transmission layer 2 to transmission layer 4, where the total number of transmission layers is 4; and
CW0 is mapped to two transmission layers and CW1 is mapped to two transmission layers, for instance, CW0 is mapped to transmission layer 1 and transmission layer 2, CW1 is mapped to transmission layer 3 and transmission layer 4, where the total number of transmission layers is 4. The layer mapping may be CW-to-layer mapping 30 as shown in FIG. 6.

Based on the above description, according to the method provided in this embodiment, the type 1 layer mapping scheme is distinguished from the type 2 layer mapping scheme according to different maximums of differences between first number of transmission layers and second number of transmission layers. The number of transmission layers after the two codewords are subjected to the layer mapping can be flexibly configured through the type 2 layer mapping scheme. Transmission requirements in different scenarios can be satisfied by flexibly configuring the number of transmission layers.

The capability information is illustratively provided below.

For instance, the capability information is configured to determine support for enabling a type 2 layer mapping scheme. Specifically, the capability information includes but is not limited to any one of information as follows.

The capability information is configured to indicate the support for enabling a type 2 layer mapping scheme for the transmission of 5 layers to 8 layers, and the transmission of 5 or more layers supports two codewords.

For instance, in a case where the type 2 layer mapping scheme is enabled for the transmission of 6 layers, the transmission of 6 layers supports two codewords. A first number of transmission layers corresponding to the first codeword 31 of the two codewords subjected to the layer mapping is 4, while a second number of transmission layers corresponding to the second codeword 32 of the two codewords subjected to the layer mapping is 2, where the difference in the number of transmission layers between the first number of transmission layers and the second number of transmission layers is 2. In other words, in the type 2 layer mapping scheme, the maximum difference in the number of transmission layers between the first number of transmission layers and the second number of transmission layers is any value from zero to six.

Optionally, in the type 2 layer mapping scheme, the maximum of the difference in the number of transmission layers between the first number of transmission layers and the second number of transmission layers is any value from two to six. Those skilled in the art can understand that the difference in the number of transmission layers between the first number of transmission layers and the second number of transmission layers is an integer.

The capability information is configured to indicate the support for enabling a type 2 layer mapping scheme for the transmission of four or more layers, and the transmission of four or more layers supports two codewords.

It should be noted that in a case where the capability information is configured to indicate the support for enabling a type 2 layer mapping scheme for the transmission of four or more layers, it includes the support for enabling the type 2 layer mapping scheme for the transmission of four layers, where the four or more layers includes four layers.

For instance, in a case where the type 2 layer mapping scheme is enabled for the transmission of 4 layers, the transmission of 4 layers supports two codewords. A first number of transmission layers corresponding to the first codeword 31 of the two codewords subjected to the layer mapping is 3, while a second number of transmission layers corresponding to the second codeword 32 of the two codewords subjected to the layer mapping is 1, where the difference in the number of transmission layers between the first number of transmission layers and the second number of transmission layers is 2. In other words, in the type 2 layer mapping scheme, a maximum of the difference in the number of transmission layers between the first number of transmission layers and the second number of transmission layers is any value from zero to six.

The capability information is configured to indicate the support for enabling a type 2 layer mapping scheme for the transmission of two or more layers, and the transmission of two or more layers supports two codewords.

It should be noted that in a case where the capability information is configured to indicate the support for enabling a type 2 layer mapping scheme for the transmission of two or more layers, it includes the support for enabling the type 2 layer mapping scheme for the transmission of two layers, where the two or more layers includes two layers.

For instance, in a case where the type 2 layer mapping scheme is enabled for the transmission of two layers, the transmission of two layers supports two codewords. A first number of transmission layers corresponding to the first codeword 31 of the two codewords subjected to the layer mapping is 2, while a second number of transmission layers corresponding to the second codeword 32 of the two codewords subjected to the layer mapping is 0, where the difference in the number of transmission layers between the first number of transmission layers and the second number of transmission layers is 2. In other words, in the type 2 layer mapping scheme, a maximum of the difference in the number of transmission layers between the first number of transmission layers and the second number of transmission layers is any value from zero to six.

Based on the above description, according to the method provided in the embodiment, the case where the terminal supports the enablement of the type 2 layer mapping scheme for the transmission of layers is described by providing the capability information. By reporting the capability information of the terminal to the network device by the terminal, the network device can understand the capability of the terminal for supporting the enablement of the type 2 layer mapping scheme. The number of transmission layers after the two codewords are subjected to the layer mapping can be flexibly configured through the type 2 layer mapping scheme. Transmission requirements in different scenarios can be satisfied by flexibly configuring the number of transmission layers.

A case where a target layer mapping scheme is determined by capability information is further provided below.

There are at least two implementations based on the embodiment shown in FIG. 2. Specifically,
implementation 1: the enablement of the type 2 layer mapping scheme is determined by the terminal; and
implementation 2: a target layer mapping scheme is determined by the network device.

The two implementations are provided respectively below.

Implementation 1: in an embodiment shown in FIG. 7, the implementation in which the enablement of the type 2 layer mapping scheme is determined by the terminal is provided.

FIG. 7 provides a flowchart of a method for reporting codeword-to-layer mapping according to an embodiment of the present disclosure. A terminal in the method may be performed by the terminal shown in FIG. 1. The method includes as follows.

Step 410: Capability information of the terminal is reported.

For instance, the capability information may include the support for enabling a type 1 layer mapping scheme, and may also include the support for enabling a type 2 layer mapping scheme.

For instance, in a case where the capability information includes the support for enabling the type 2 layer mapping scheme, the capability information may indicate the enablement of the type 2 layer mapping scheme for different transmission layers for the terminal. Specifically, the capability information includes but is not limited to any one of the following:
support for enabling a type 2 layer mapping scheme for the transmission of five layers to eight layers, where the transmission of five or more layers supports two codewords;
support for enabling a type 2 layer mapping scheme for the transmission of four or more layers, where the transmission of four or more layers supports two codewords; and
support for enabling a type 2 layer mapping scheme for the transmission of two or more layers, where the transmission of two or more layers supports two codewords.

Step 420: a target layer mapping scheme is determined and enabled based on the capability information.

The target layer mapping scheme is a type 1 layer mapping scheme or a type 2 layer mapping scheme.

For instance, in the type 1 layer mapping scheme, the difference in the number of transmission layers between the first number of transmission layers and the second number of transmission layers is zero or one.

In the type 2 layer mapping scheme, the maximum difference in the number of transmission layers between the first number of transmission layers and the second number of transmission layers is any value from zero to six.

The two codewords include a first codeword and a second codeword. A first number of transmission layers corresponds to the first codeword subjected to layer mapping, and a second number of transmission layers corresponds to the second codeword subjected to the layer mapping.

For instance, in this embodiment, the target layer mapping scheme is determined by the terminal. In other words, the target layer mapping scheme is determined and enabled by the terminal based on the capability information. The network device is not configured to determine the target layer mapping scheme, rather, only accepts the capability information transmitted by the terminal. In other words, the target layer mapping scheme corresponding to the capability information reported by the terminal takes effect by default and does not require indication from the network device.

In an optional embodiment, step 420 may be implemented as at least one of two sub-steps as follows:
sub-step 1: in the case where the capability information indicates support for enabling the type 2 layer mapping scheme, the type 2 layer mapping scheme is determined and enabled according to the capability information; and
sub-step 2: in the case where the capability information indicates that the enablement of the type 2 layer mapping scheme is not supported, the type 1 layer mapping scheme is determined and enabled according to the capability information.

For instance, in a case where the capability information indicates the support for enabling the type 2 layer mapping scheme for the transmission of five layers to eight layers, where the transmission of five or more layers supports two codewords, the type 2 layer mapping scheme is determined and enabled.

According to the method provided in the embodiment, by reporting the capability information of the terminal to the network device by the terminal, the network device can understand the capability of the terminal for supporting the enablement of the type 2 layer mapping scheme. The target layer mapping scheme can be determined by the terminal independently according to the capability information. In this way, transmission requirements in different scenarios can be satisfied by flexibly configuring the number of transmission layers.

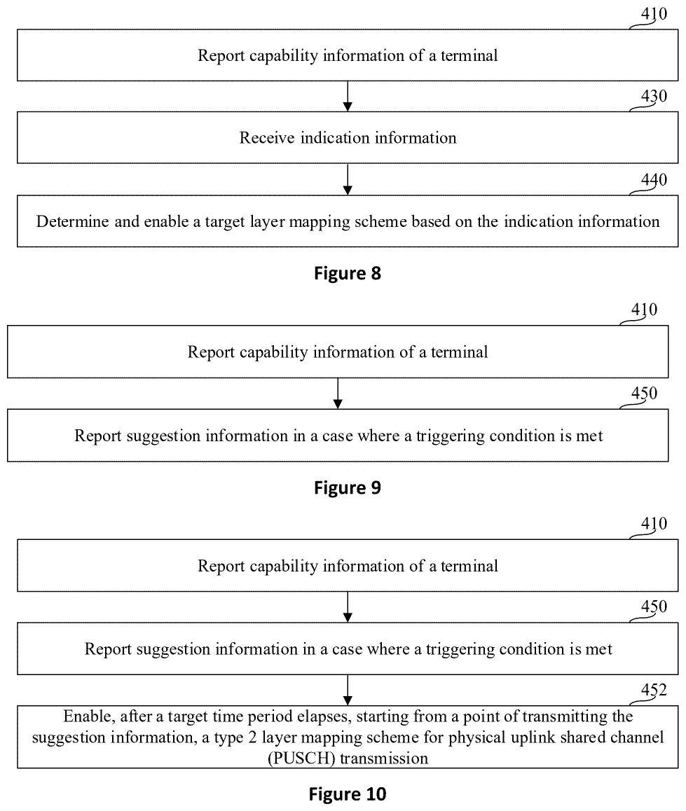

Implementation 2: in an embodiment shown in FIG. 8, the implementation in which the target layer mapping scheme is determined by the network device is provided.

FIG. 8 provides a flowchart of a method for reporting codeword-to-layer mapping according to an embodiment of the present disclosure. A terminal in the method may be performed by the terminal shown in FIG. 1. The method includes as follows.

Step 410: capability information of the terminal is reported.

For instance, the capability information may include support for enabling a type 1 layer mapping scheme, and may also include support for enabling a type 2 layer mapping scheme.

Step 430: indication information is received.

The indication information is configured to determine and enable a target layer mapping scheme. Correspondingly, the indication information is transmitted by the network device.

For instance, in this embodiment, the target layer mapping scheme is determined by the network device. The indication information is transmitted by the network device to be configured to determine and enable the target layer mapping scheme. The indication information is transmitted to the terminal by the network device and is received by the terminal. In other words, the terminal waits for the indication information after reporting the capability information of the terminal, and the indication is transmitted by the network device.

Step 440: a target layer mapping scheme is determined and enabled based on the indication information.

The target layer mapping scheme is a type 1 layer mapping scheme or a type 2 layer mapping scheme.

For instance, in the type 1 layer mapping scheme, the difference in the number of transmission layers between the first number of transmission layers and the second number of transmission layers is zero or one.

In the type 2 layer mapping scheme, the maximum difference in the number of transmission layers between the first number of transmission layers and the second number of transmission layers is any value from zero to six.

The two codewords include a first codeword and a second codeword. A first number of transmission layers corresponds to the first codeword subjected to layer mapping, and a second number of transmission layers corresponds to the second codeword subjected to the layer mapping.

According to the method provided in the embodiment, by reporting the capability information of the terminal to the network device by the terminal, the network device can understand the capability of the terminal for supporting the enablement of the type 2 layer mapping scheme. By determining the target layer mapping scheme according to the indication information transmitted by the network device, the target layer mapping scheme is determined and enabled based on the capability information. In this way, transmission requirements in different scenarios can be satisfied by flexibly configuring the number of transmission layers.

Suggestion information is provided below in three embodiments as follows:

FIG. 9 provides a flowchart of a method for reporting codeword-to-layer mapping according to an embodiment of the present disclosure. A terminal in the method may be performed by the terminal shown in FIG. 1. The method includes as follows.

Step 410: capability information of the terminal is reported.

For instance, the capability information may include support for enabling a type 1 layer mapping scheme. The capability information may also include support for enabling a type 2 layer mapping scheme.

Step 450: suggestion information is reported in a case where a triggering condition is met.

For instance, the suggestion information is configured to suggest that the network device indicate the enablement of the type 2 layer mapping scheme. Correspondingly, the suggestion information is received by the network device.

It should be noted that the suggestion information is configured to suggest a layer mapping scheme indicated by the network device. The suggestion information is merely an illustrative name and may be named as any one of change information, reconfiguration information and triggering information. Further, information for suggesting the layer mapping scheme indicated by the network device may be transmitted separately or simultaneously with other information. In a case where the information is used to suggest the layer mapping scheme indicated by the network device, the information is considered as suggestion information.

For instance, the suggestion information includes, but is not limited to, being carried in at least one of the following signaling: radio resource control (RRC) signaling, media access control control element (MAC CE) signaling, and uplink control information (UCI) signaling.

For instance, the suggestion information is carried in the following information field of the UCI signaling: a newly added indication field, or a codepoint in a demodulation reference symbol (DMRS) indication field.

For instance, the triggering condition includes but is not limited to at least one of:
in the scenario of single transmission reception point (TRP) transmission or multi-TRP transmission, it is detected that the signal quality difference between layers is greater than a first threshold;
in the scenario of multi-TRP transmission, it is detected that the channel quality indication difference of the cooperating TRPs is greater than a second threshold;
a signal quality difference between a group of reporting beams measured during beam measurement is greater than a third threshold;
a consecutive retransmission event of a transport block (TB) occurs under multi-layer transmission;
a counter configured for the consecutive retransmission event of the TB under the multi-layer transmission reaches a fourth threshold; and
a timer configured for the consecutive retransmission event of the TB under the multi-layer transmission expires.

For instance, the first threshold to the fourth threshold mentioned above may be the same or different, which is not limited in the embodiment.

According to the method provided in the embodiment, it enables the terminal to report suggestion information to the network device, allowing the terminal to propose a suggestion for indicating enablement of the type 2 layer mapping scheme when the triggering condition is met. This achieves a more flexible approach for determining the target layer mapping scheme. The terminal can determine the layer mapping scheme based on the suggestion information, and by flexibly configuring the number of transmission layers, it can meet the transmission requirements in different scenarios.

A case where a target layer mapping scheme is determined by means of suggestion information is further provided below.

There are at least two implementations based on the embodiment shown in FIG. 9. Specifically,
implementation 1: enablement of the type 2 layer mapping scheme is determined by the terminal; and
implementation 2: the target layer mapping scheme is determined by the network device.

The implementations are provided below, respectively.

Implementation 1: in an embodiment shown in FIG. 10, the implementation in which the enablement of the type 2 layer mapping scheme is determined by the terminal is provided.

FIG. 10 shows a flowchart of a method for reporting codeword-to-layer mapping according to an embodiment of the present disclosure. The terminal in the method may be performed by the terminal shown in FIG. 1. In an optional embodiment, step 452 is further included based on the embodiment shown in FIG. 9.

Step 450: suggestion information is reported in a case where a triggering condition is met.

For instance, the suggestion information is configured to suggest that the network device indicate enablement of the type 2 layer mapping scheme. Correspondingly, the suggestion information is received by the network device.

Step 452: after a target time period elapses, starting from a point of transmitting the suggestion information, the type 2 layer mapping scheme is enabled for physical uplink shared channel (PUSCH) transmission.

Correspondingly, after a target time period elapses, starting from a point of receiving the suggestion information, the type 2 layer mapping scheme is enabled by the network device for physical uplink shared channel (PUSCH) reception.

For instance, the target time period is predefined, or determined through reporting by the terminal. Those skilled in the art can understand that the target time period may also be determined by the network device or determined through negotiation between the terminal and the network device. For instance, in a case where the target time period is predefined, the target time period is predefined by setting the target time period in a communication protocol.

For instance, in the embodiment, the enablement of the type 2 layer mapping scheme is determined by the terminal. In other words, the type 2 layer mapping scheme is determined and enabled by the terminal based on the suggestion information. The network device is not configured to determine and enable the type 2 layer mapping scheme, rather, only accepts the suggestion information transmitted by the terminal. In other words, the type 2 layer mapping scheme corresponding to the suggestion information reported by the terminal takes effect by default and is not required to be indicated by the network device.

According to the method provided in the embodiment, by reporting the suggestion information to the network device by the terminal, the terminal can propose a suggestion for indicating enablement of the type 2 layer mapping scheme when the triggering condition is met. In this way, it is a more flexible method for determining a target layer mapping scheme. The terminal can independently determine the layer mapping scheme based on the suggestion information, and by flexibly configuring the number of transmission layers, it can meet the transmission requirements in different scenarios.

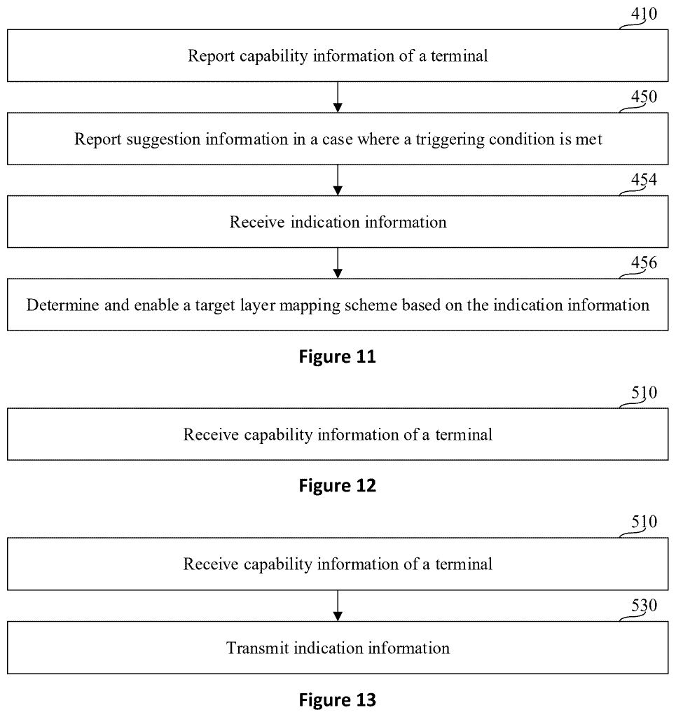

Implementation 2: in an embodiment shown in FIG. 11, the implementation in which the target layer mapping scheme is determined by the network device is provided.

FIG. 11 shows a flowchart of a method for reporting codeword-to-layer mapping according to an embodiment of the present disclosure. The terminal in the method may be executed by the terminal shown in FIG. 1. In an optional embodiment, steps 454 and 456 are further included based on the embodiment shown in FIG. 9.

Step 450: suggestion information is reported in a case where a triggering condition is met.

For instance, the suggestion information is configured to suggest that the network device indicate enablement of the type 2 layer mapping scheme. Correspondingly, the suggestion information is received by the network device.

Step 454: indication information is received.

The indication information is configured to determine and enable a target layer mapping scheme. Correspondingly, the indication information is transmitted by the network device. The indication information is generated by the network device according to the suggestion information.

For instance, in the embodiment, the target layer mapping scheme is determined by the network device. The indication information is transmitted by the network device to be configured to determine and enable the target layer mapping scheme. The indication information is transmitted to the terminal by the network device and is received by the terminal. In other words, the terminal waits for the indication information after reporting the suggestion information, and an indication is transmitted by the network device.

Step 456: a target layer mapping scheme is determined and enabled based on the indication information.

For instance, the target layer mapping scheme is a type 1 layer mapping scheme or a type 2 layer mapping scheme.

For instance, in the type 1 layer mapping scheme, the difference in the number of transmission layers between the first number of transmission layers and the second number of transmission layers is zero or one.

In the type 2 layer mapping scheme, the maximum difference in the number of transmission layers between the first number of transmission layers and the second number of transmission layers is any value from zero to six.

The two codewords include a first codeword and a second codeword. A first number of transmission layers corresponds to the first codeword subjected to layer mapping, and a second number of transmission layers corresponds to the second codeword subjected to the layer mapping.

According to the method provided in the embodiment, by reporting the suggestion information to the network device by the terminal, the terminal can propose a suggestion for indicating enablement of the type 2 layer mapping scheme when the triggering condition is met. In this way, it is a more flexible method for determining a target layer mapping scheme. Since the terminal determines the layer mapping scheme by the indication information transmitted by the network device, the layer mapping scheme is determined based on the suggestion information. In this way, transmission requirements in different scenarios can be satisfied by flexibly configuring the number of transmission layers.

FIG. 12 provides a flowchart of a method for receiving codeword-to-layer mapping according to an embodiment of the present disclosure. A network device in the method may be performed by the network device shown in FIG. 1. The method includes as follows.

Step 510: capability information of a terminal is received.

For instance, the capability information is configured to determine support for enabling a type 2 layer mapping scheme. For instance, the capability information may indicate the support for enabling a type 2 layer mapping scheme for terminal transmission, and may also indicate the support for enabling a type 2 layer mapping scheme for different layer transmission of the terminal. The description dimension of the capability information is not limited in the present disclosure.

For instance, in an uplink or a downlink, a target layer mapping scheme is determined, enabled, activated or supported. In other words, in the uplink, a type 1 layer mapping scheme or a type 2 layer mapping scheme is determined and enabled by the terminal. In the downlink, a type 1 layer mapping scheme or a type 2 layer mapping scheme is determined and enabled by the network device. In an embodiment, an uplink scenario is provided for illustration in an embodiment of the present disclosure.

According to the method provided in the embodiment, it enables the network device to understand the capability of the terminal for supporting the enablement of the type 2 layer mapping scheme by having the terminal report its capability information to the network device. The type 2 layer mapping scheme can allow flexible configuration of the number of transmission layers after mapping two codewords to layers, which can, in turn, meet the transmission requirements of different scenarios through this flexible configuration of transmission layers.

FIG. 13 provides a flowchart of a method for receiving codeword-to-layer mapping according to an embodiment of the present disclosure. A network device in the method may be performed by the network device shown in FIG. 1. The method includes as follows.

Step 510: capability information of a terminal is received.

For instance, the capability information may include support for enabling a type 1 layer mapping scheme, and may also include support for enabling of a type 2 layer mapping scheme.

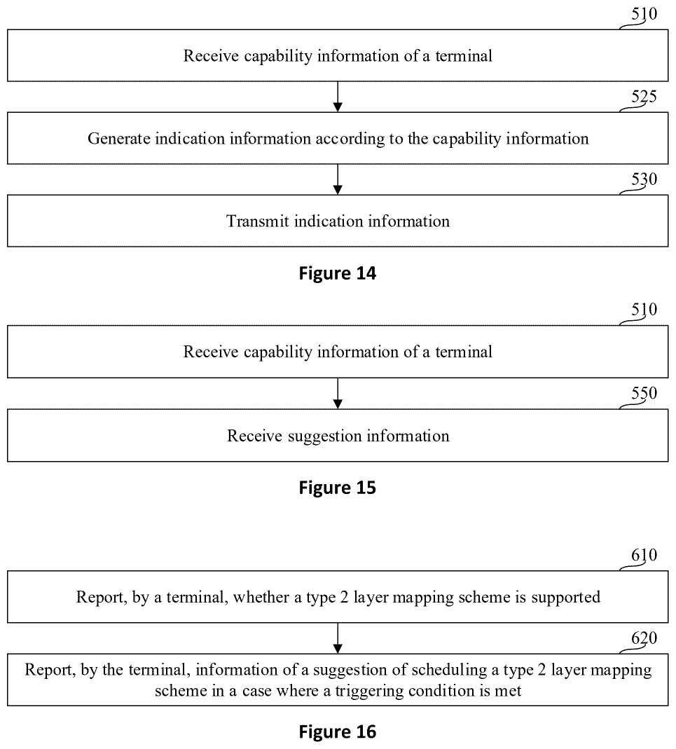

Optionally, as shown in FIG. 14, in an optional embodiment, step 525 is further included on the basis of the embodiment.

Step 525: indication information is generated according to the capability information.

For instance, the indication information is determined by the network device according to the capability information reported by the terminal. The indication information is configured to determine and enable the target layer mapping scheme. For instance, the target layer mapping scheme indicated by the indication information matches the type 2 layer mapping scheme that is supported for enablement indicated by the capability information.

Specifically, step 525 may be implemented as at least one of two sub-steps as follows.

Sub-step 1: first indication information is generated in a case where the capability information indicates support for enabling the type 2 layer mapping scheme. The first indication information is configured to indicate the enablement of the type 2 layer mapping scheme.

For instance, the indication information indicates the layer mapping scheme by means of 1-bit information. For instance, in a case where the bit information is 1, the indication information is configured to indicate the enablement of the type 2 layer mapping scheme. In a case where the bit information is 0, the indication information is configured to indicate the enablement of the type 1 layer mapping scheme.

Optionally, in an implementation, in a case where the capability information indicates support for enabling a type 2 layer mapping scheme for the transmission of five layers to eight layers, the first indication information is generated. The first indication information is configured to indicate the enablement of the type 2 layer mapping scheme for the transmission of five layers to eight layers.

Optionally, in another implementation, in a case where the capability information indicates support for enabling a type 2 layer mapping scheme for the transmission of four or more layers, the first indication information is generated. The first indication information is configured to indicate the enablement of the type 2 layer mapping scheme for the transmission of four or more layers.

Optionally, in another implementation, in a case where the capability information indicates support for enabling a type 2 layer mapping scheme for the transmission of two or more layers, the first indication information is generated. The first indication information is configured to indicate the enablement of the type 2 layer mapping scheme for the transmission of two or more layers.

For instance, the indication information indicates the layer mapping scheme by means of 2-bit information. For instance, in a case where the bit information is 00, the indication information is configured to indicate enablement of a type 1 layer mapping scheme. In a case where the bit information is 01, the indication information is configured to indicate enablement of the type 2 layer mapping scheme for the transmission of five layers to eight layers. In a case that the bit information is 10, the indication information is configured to indicate enablement of the type 2 layer mapping scheme for the transmission of four or more layers. In a case where the bit information is 11, the indication information is configured to indicate enablement of the type 2 layer mapping scheme for the transmission of two or more layers.

Sub-step 2: second indication information is generated in a case where the capability information indicates the enablement of the type 2 layer mapping scheme is not supported. The second indication information is configured to indicate enablement of the type 1 layer mapping scheme.

Step 530: indication information is transmitted.

The indication information is configured to determine and enable a target layer mapping scheme.

For instance, in the embodiment, the target layer mapping scheme is determined by the network device. The indication information is transmitted by the network device to be configured to determine and enable the target layer mapping scheme. The indication information is transmitted to the terminal by the network device and is received by the terminal. In other words, the terminal waits for the indication information after reporting the capability information of the terminal, and an indication is transmitted by the network device.

According to the method provided in an embodiment, by reporting the capability information of the terminal to the network device by the terminal, the network device can understand the capability of the terminal for supporting the enablement of the type 2 layer mapping scheme. By determining the target layer mapping scheme according to the indication information transmitted by the network device, the target layer mapping scheme is determined and enabled based on the capability information. Transmission requirements in different scenarios can be satisfied by flexibly configuring the number of transmission layers.

FIG. 15 provides a flowchart of a method for receiving codeword-to-layer mapping according to an embodiment of the present disclosure. A network device in the method may be performed by the network device shown in FIG. 1. The method includes as follows.

Step 510: capability information of a terminal is received.

For instance, the capability information may include support for enabling a type 1 layer mapping scheme, and may also include support for enabling a type 2 layer mapping scheme.

Optionally, in an optional embodiment, the following step is further included on the basis of the embodiment:
the indication information is generated according to the suggestion information.

The above process may be implemented as at least one of two sub-steps as follows.

Sub-step 1: the suggestion information is accepted, and first indication information is generated according to the suggestion information. The first indication information is configured to indicate the enablement of the type 2 layer mapping scheme.

Sub-step 2: the suggestion information is rejected, and second indication information is generated according to the suggestion information. The second indication information is configured to indicate enablement of the type 1 layer mapping scheme.

Step 550: the suggestion information is received.

For instance, the suggestion information is configured to suggest that the network device indicate enablement of the type 2 layer mapping scheme.

It should be noted that the suggestion information is configured to suggest a layer mapping scheme indicated by the network device. The suggestion information is merely an illustrative name and may be named as any one of change information, reconfiguration information and triggering information. Further, information for suggesting the layer mapping scheme indicated by the network device may be transmitted separately or simultaneously with other information. In a case where the information is configured to suggest the layer mapping scheme indicated by the network device, the information is considered as the suggestion information.

In an optional implementation, the suggestion information is carried in at least one of a RRC signaling, a MAC CE signaling, and a UCI signaling.

Optionally, in an optional embodiment, the following step is further included on the basis of embodiment:
after a target time period elapses, starting from a point of receiving the suggestion information, the type 2 layer mapping scheme is enabled by the network device for PUSCH reception.

For instance, the target time period is predefined, or determined through reporting by the terminal. Those skilled in the art can understand that the target time period may also be determined by the network device, or determined through negotiation between the terminal and the network device.

Optionally, in an optional embodiment, the following step is further included on the basis of the example:
indication information is transmitted. The indication information is generated by the network device according to the suggestion information.

For instance, in an optional embodiment, the target layer mapping scheme is determined by the network device. The indication information is transmitted by the network device to be configured to determine and enable the target layer mapping scheme. The indication information is transmitted to the terminal by the network device and is received by the terminal. In other words, the terminal waits for the indication information after reporting the suggestion information, and an indication is transmitted by the network device.

According to the method provided in the embodiment, by reporting the suggestion information to the network device by the terminal, the terminal can propose a suggestion for indicating enablement of the type 2 layer mapping scheme when the triggering condition is met. In this way, it is a more flexible method for determining a target layer mapping scheme. The terminal can determine the layer mapping scheme based on the suggestion information, and by flexibly configuring the number of transmission layers, it can meet the transmission requirements in different scenarios.

FIG. 16 provides a flowchart of a method for reporting codeword-to-layer mapping according to an embodiment of the present disclosure. A terminal in the method may be performed by the terminal shown in FIG. 1. The method includes as follows.

Step 610: whether a type 2 layer mapping scheme is supported is reported by a terminal.

For instance, reporting is carried out by the terminal by means of at least one of an RRC signaling, an MAC CE signaling and a UCI signaling.

Specifically, reporting whether a type 2 layer mapping scheme is supported by the terminal involves at least three capability types as follows:
capability type 1: only a type 2 layer mapping scheme for four or more layers is supported by the terminal;
capability type 2: a type 2 layer mapping scheme for four or more layers is supported by the terminal, where four layers support flexible layer mapping of two codewords.
capability type three: a type 2 layer mapping scheme for two or more layers is supported by the terminal, where two to four layers support flexible layer mapping of two codewords.

The type 1 layer mapping scheme and the type 2 layer mapping scheme are provided below.

### A Type 1 Layer Mapping Scheme:

For instance, the codeword-to-layer mapping is implemented in as balanced a manner as possible. When the rank is odd, codeword 0 has one fewer layer than codeword 1. When the rank is even, the codeword-to-layer mapping ensures that both codewords correspond to the same number of transmission layers.

### A Type 2 Layer Mapping Scheme:

For instance, in a case of flexible codeword layer mapping for five layers to eight layers:

the flexible mapping is also divided into two codewords, but the number of transmission layers corresponding to each codeword is not restricted and is determined based on the actual channel conditions. As a result, various combinations may occur. For example, in a six-layer transmission, CW0 may correspond to four layers of data, while CW1 corresponds to two layers of data.

Optionally, in a case where two layers to four layers correspond to one codeword, two codewords are also configured for flexible mapping.

In the uplink or downlink layer mapping schemes, cases where the number of data layers is 2 to 4 correspond to the transmission of one codeword. However, this configuration makes it difficult for the same modulation and coding scheme (MCS) to adapt to different channel conditions across layers. Therefore, in cases where there is a significant difference in channel performance between layers, performance losses may occur. As a result, for two to four layers, or specifically for four layers of data, two codewords are used for scheduling and transmission. This allows the network to schedule transmissions more effectively based on the channel conditions between layers.

For example, in three-layer transmission, when there is a significant difference between the channel conditions of the layers, two codewords can be used for scheduling. One codeword transmits data on one layer, and the other codeword transmits data on two layers. This approach also facilitates retransmission scheduling, which helps improve system throughput. Since most transmissions involve fewer than four layers, this is beneficial for overall performance optimization.

Step 620: in a case where the triggering condition is met, information of a suggestion of scheduling a type 2 layer mapping scheme is reported by the terminal.

For instance, a suggestion that a network scheduling rule be a type 2 layer mapping scheme is reported by the terminal via MAC CE signaling.

Optionally, a suggestion that a network scheduling rule be a type 2 layer mapping scheme is reported by the terminal via the MAC CE signaling through measurement. For example, an independent indication field is added to the DCI signaling, or the information load is increased through the codepoint in the DMRS indication field.

For instance, the triggering condition includes but is not limited to at least one of:
in a single-transmission reception point (S-TRP) or multiple-transmission reception point (M-TRP) scenario, the terminal detects that a signal to interference plus noise ratio (SINR) difference between layers is greater than a first threshold;
in the M-TRP scenario, the terminal determines a channel quality indicator (CQI) difference between cooperating TRPs is greater than a second threshold through measurement;
a reference signal received power (RSRP) or L1-SINR difference of a group of reporting beams measured by the terminal during beam measurement is greater than a third threshold; or
a consecutive retransmission event of a TB occurs under multi-layer transmission, for instance, a counter configured for the consecutive retransmission event reaches a fourth threshold, or a timer configured for the consecutive retransmission event expires.

Further, after information of the suggestion to schedule the type 2 layer mapping scheme is reported by the terminal, scheduling of the layer mapping scheme may be determined by the base station. Alternatively, after reporting by the terminal, the layer mapping scheme is changed by the base station by default, and the scheduling of the layer mapping scheme is determined by the terminal.

For instance, in a case where the scheduling of the layer mapping scheme is determined by the terminal, decision effective time is defined by the terminal. In cases where the type 2 layer mapping scheme is applicable for PUSCH transmission, i.e., when transmitting rank indication (RI) is restricted, the type 2 layer mapping scheme is used by default for PUSCH transmission.

According to the method provided in the embodiment, by reporting the capability information of the terminal to the network device by the terminal, the network device can understand the capability of the terminal for supporting the enablement of the type 2 layer mapping scheme. The number of transmission layers after the two codewords are subjected to the layer mapping can be flexibly configured through the type 2 layer mapping scheme. Transmission requirements in different scenarios can be satisfied by flexibly configuring the number of transmission layers.

A person skilled in the art can understand that the above embodiments may be implemented independently, or may be freely combined to form new embodiments, which is not limited in the present disclosure.

Device embodiments of the present disclosure are described below and can be configured to perform method embodiments of the present disclosure. For details not disclosed in the device embodiments of the present disclosure, reference can be made to the method embodiments of the present disclosure.

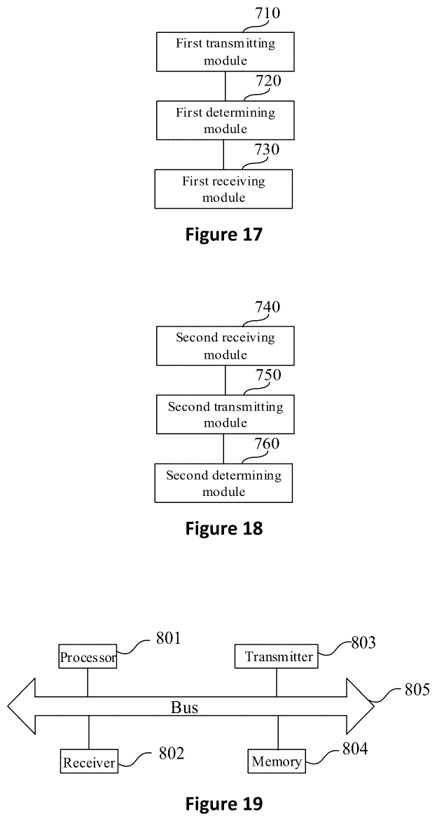

FIG. 17 illustrates a block diagram of a device for reporting codeword-to-layer mapping according to an example of the present disclosure. The device includes as follows:
a first transmitting module 710, configured to report capability information of the terminal. The capability information is configured to determine support for enabling a type 2 layer mapping scheme.

The maximum difference in the number of transmission layers after two codewords are subjected to layer mapping is different respectively for a type 1 mapping scheme and the type 2 layer mapping scheme.

In an optional example, the two codewords include a first codeword and a second codeword. The first number of transmission layers corresponds to the first codeword subjected to layer mapping. The second number of transmission layers corresponds to the second codeword subjected to the layer mapping.

The difference in the number of transmission layers between the first number of transmission layers and second number of transmission layers using the type 1 layer mapping scheme is zero or one.

The maximum difference in the number of transmission layers between the first number of transmission layers and the second number of transmission layers using the type 2 layer mapping scheme is any value from zero to six.

In an optional example, the capability information is configured to indicate:
support for enabling a type 2 layer mapping scheme for transmission of five layers to eight layers, where the transmission of five or more layers supports the two codewords;
support for enabling a type 2 layer mapping scheme for transmission of four or more layers (including four layers), where the transmission of four or more layers supports the two codewords; or
support for enabling a type 2 layer mapping scheme for transmission of two or more layers, where the transmission of two or more layers supports the two codewords.

In an optional example, the device further includes:
a first determining module 720, configured to determine and enable a target layer mapping scheme based on the capability information. The target layer mapping scheme is the type 1 layer mapping scheme or the type 2 layer mapping scheme.

In an optional example, the first determining module 720 is further configured to:
determine and enable, in a case where the capability information indicates the support for enabling the type 2 layer mapping scheme, the type 2 layer mapping scheme according to the capability information; or
determine and enable, in a case where the capability information indicates that enablement of the type 2 layer mapping scheme is not supported, the type 1 layer mapping scheme according to the capability information.

In an optional example, the device further includes:
a first receiving module 730, configured to receive indication information; and
a first determining module 720, configured to determine and enable a target layer mapping scheme based on the indication information, where the target layer mapping scheme is the type 1 layer mapping scheme or the type 2 layer mapping scheme.

In an optional example, the first transmitting module 710 is further configured to report suggestion information in a case where a triggering condition is met, where the suggestion information is configured to suggest that a network device indicate enablement of the type 2 layer mapping scheme.

In an optional example, the triggering condition includes at least one of:
a signal quality difference between layers is detected to be greater than a first threshold in a scenario of single-TRP transmission or multi-TRP transmission;
a channel quality indication difference between cooperating TRPs is detected to be greater than a second threshold in the scenario of the multi-TRP transmission;
a signal quality difference between a group of reporting beams measured during beam measurement is greater than a third threshold;
a consecutive retransmission event of a TB occurs under a multi-layer transmission;
a counter configured for the consecutive retransmission event under a multi-layer transmission reaches a fourth threshold; or
a timer configured for the consecutive retransmission event under a multi-layer transmission expires.

In an optional example, the suggestion information is carried in at least one of an RRC signaling, an MAC CE signaling or a UCI signaling.

In an optional example, the device further includes:
a first receiving module 730 configured to receive indication information, where the indication information is generated by the network device according to the suggestion information; and
a first determining module 720, configured to determine and enable a target layer mapping scheme based on the indication information, where the target layer mapping scheme is the type 1 layer mapping scheme or the type 2 layer mapping scheme.

In an optional example, the first transmitting module 710 is further configured to enable, after a target time period elapses, starting from a point of transmitting the suggestion information, the type 2 layer mapping scheme for PUSCH transmission.

In an optional example, the target time period is predefined; or the target time period is determined through reporting by the terminal.

FIG. 18 illustrates a block diagram of a device for receiving codeword-to-layer mapping according to an example of the present disclosure. The device includes as follows:
a second receiving module 740, configured to receive capability information of a terminal. The capability information is configured to determine support for enabling a type 2 layer mapping scheme.

The maximum difference in the number of transmission layers after two codewords are subjected to layer mapping is different respectively for a type 1 mapping scheme and the type 2 layer mapping scheme.

In an optional example, the two codewords include a first codeword and a second codeword. The first number of transmission layers corresponds to the first codeword subjected to layer mapping, and the second number of transmission layers corresponds to the second codeword subjected to the layer mapping.

The difference in the number of transmission layers between the first number of transmission layers and second number of transmission layers using the type 1 layer mapping scheme is zero or one.

The maximum difference in the number of transmission layers between the first number of transmission layers and the second number of transmission layers using the type 2 layer mapping scheme is any value from zero to six.

In an optional example, the capability information is configured to indicate:
support for enabling a type 2 layer mapping scheme for transmission of five layers to eight layers;
support for enabling a type 2 layer mapping scheme for transmission of four or more layers, where the transmission of four or more layers supports the two codewords; or
support for enabling a type 2 layer mapping scheme for transmission of two or more layers, where the transmission of two or more layers supports the two codewords.

In an optional example, the device further includes:
a second transmitting module 750, configured to transmit indication information. The indication information is configured to determine and enable a target layer mapping scheme. The target layer mapping scheme is the type 1 layer mapping scheme or the type 2 layer mapping scheme.

In an optional example, the device further includes:
a second determining module 760, configured to generate the indication information according to the capability information.

In an optional example, the second determining module 760 is further configured to:
generate first indication information in a case where the capability information indicates the support for enabling the type 2 layer mapping scheme, where the first indication information is configured to indicate enablement of the type 2 layer mapping scheme; or
generate second indication information in a case where the capability information indicates that the enablement of the type 2 layer mapping scheme is not supported, where the second indication information is configured to indicate enablement of the type 1 layer mapping scheme.

In an optional example, the second receiving module 740 is further configured to:
receive suggestion information. The suggestion information is configured to suggest that the network device indicate enablement of the type 2 layer mapping scheme.

In an optional example, the suggestion information is carried in at least one of:
an RRC signaling, an MAC CE signaling, or a UCI signaling.

In an optional example, the device further includes:
a second determining module 760, configured to generate the indication information according to the suggestion information.

In an optional example, the second determining module 760 is further configured to:
accept the suggestion information, and generate first indication information according to the suggestion information, where the first indication information is configured to indicate the enablement of the type 2 layer mapping scheme; or
reject the suggestion information, and generate second indication information according to the suggestion information, where the second indication information is configured to indicate enablement of the type 1 layer mapping scheme.

In an optional example, the second receiving module 740 is further configured to:
enable, after a target time period elapses, starting from a point of receiving the suggestion information, the type 2 layer mapping scheme for PUSCH reception.

In an optional example, the target time period is predefined, or determined through reporting by the terminal.

It should be noted that, when implementing the functions of the device provided by the above embodiments, the division of the functional modules mentioned is merely an example. In practical applications, the functions may be allocated to different functional modules as needed. In other words, the internal structure of the device can be divided into different functional modules to accomplish all or part of the functions described above.

Regarding the device in the above embodiments, the specific manner in which each module performs operations has already been described in detail in the embodiments related to the method, which will not be elaborated further here.

FIG. 19 is a schematic structural diagram of a communication device according to an embodiment of the present disclosure. The communication device may include a processor 801, a receiver 802, a transmitter 803, a memory 804 and a bus 805.

The processor 801 includes one or more processing cores. The processor 801 runs software programs and modules to execute various function applications and information processing.

The receiver 802 and the transmitter 803 may be implemented as a transceiver. The transceiver may be a communication chip.

The memory 804 is connected to the processor 801 via the bus 805. For instance, the processor 801 may be implemented as a first integrated circuit (IC) chip, and the processor 801 and the memory 804 may be jointly implemented as a second IC chip. The first chip or the second chip may be an application specific integrated circuit (ASIC) chip.

The memory 804 may be configured to store at least one computer program. The processor 801 is configured to execute the at least one computer program to implement various steps in the above method embodiments.

Furthermore, the memory 804 may be implemented by any type or combination of volatile or nonvolatile storage devices, which include but are not limited to a random-access memory (RAM), a read-only memory (ROM), an erasable programmable read-only memory (EPROM), an electrically erasable programmable read-only memory (EEPROM), a flash memory or other solid state storage technologies, a compact disc read-only memory (CD-ROM), a digital video disc (DVD) or other optical storages, a magnetic cassette, a magnetic tape, and a magnetic disk storage or other magnetic storage devices.

A non-transitory computer-readable storage medium is further provided according to an embodiment of the present disclosure. The non-transitory computer-readable storage medium stores a computer program. The computer program is configured to be executed by a processor of a multi-link device to implement the above method for reporting and receiving codeword-to-layer mapping.

Optionally, the non-transitory computer-readable storage medium may include a read-only memory (ROM), a random-access memory (RAM), solid state drives (SSD) or an optical disk. The random access memory may include a resistance random access memory (ReRAM) and a dynamic random access memory (DRAM).

A chip is further provided according to an embodiment of the present disclosure. The chip includes a programmable logic circuit and/or program instructions. When running on a multi-link device, the chip is configured to implement the above method for reporting and receiving codeword-to-layer mapping.

A computer program product is further provided according to an embodiment of the present disclosure. The computer program product includes computer instructions. The computer instructions are stored on a non-transitory computer-readable storage medium. A processor of a multi-link device reads the computer instructions from the non-transitory computer-readable storage medium and executes the computer instructions to implement the above method for reporting and receiving codeword-to-layer mapping.

Technical solutions provided by embodiments of the present disclosure can have beneficial effects as follows.

By reporting the capability information of the terminal to the network device by the terminal, the network device can understand the capability of the terminal for supporting the enablement of the type 2 layer mapping scheme. The number of transmission layers after the two codewords are subjected to the layer mapping can be flexibly configured through the type 2 layer mapping scheme. Transmission requirements in different scenarios can be satisfied by flexibly configuring the number of transmission layers.

It should be understood that the term “indicate” mentioned in an example of the present disclosure may means “directly indicate,” “indirectly indicate,” and “have an association relation”. For instance, “A indicates B” may represent that A directly indicates B, for instance, B may be acquired through A; may represent that A indirectly indicates B, for instance, A indicates C, and B may be acquired through C; and may also represent that A and B have an association relation. In the descriptions of embodiments of the present disclosure, the term “correspond (to)” may indicate that two objects have a direct or indirect corresponding relation, an association relation, an indicating and instructed relation, a configuring and configured relation, etc. The term “a plurality of” mentioned here refers to two or more than two. The term “and/or” describing an association relation between associated objects indicates that there can be three relationships. For instance, A and/or B can represent A alone, both A and B, and B alone. The character “/” generally indicates that associated objects in the context are in an “or” relationship.

In addition, step numbers described here only illustratively show a possible execution sequence of the steps. In some other embodiments, the above steps may also be executed not in the number sequence. For instance, two steps having different numbers are executed simultaneously or in a reverse sequence of that shown in the figure, which is not limited in an example of the present disclosure.

Those skilled in the art should note that in one or more of the above instances, the functions described in embodiments of the present disclosure may be implemented by hardware, software, firmware, or their combinations. In a case that the functions are implemented by software, the functions may be stored in a computer-readable medium or configured as one or more instructions or code on the computer-readable medium for transport. The computer-readable medium includes a computer storage medium and a communication medium. The communication medium includes any medium which can conveniently transfer a computer program from one place to another. The storage medium may be any available medium which can be accessed by a general-purpose or special-purpose computer.

The above descriptions are merely embodiments of the present disclosure and not intended to limit the present disclosure. Any modifications, equivalent substitutions, improvements, etc. made within the spirit and principles of the present disclosure should all fall within the scope of protection of the present disclosure.

1. A method for reporting codeword-to-layer mapping, performed by a terminal, the method comprising:
reporting capability information of the terminal, wherein the capability information is configured to determine support for enabling a type 2 layer mapping scheme; wherein
a maximum difference in a number of transmission layers after two codewords are subjected to layer mapping is different respectively for a type 1 mapping scheme and the type 2 layer mapping scheme.

2. The method according to claim 1, wherein the two codewords comprise a first codeword and a second codeword, and a first number of transmission layers corresponds to the first codeword subjected to layer mapping, and a second number of transmission layers corresponds to the second codeword subjected to layer mapping; wherein,
a difference in a number of transmission layers between the first number of transmission layers and second number of transmission layers using the type 1 layer mapping scheme is zero or one; and
the maximum difference in a number of transmission layers between the first number of transmission layers and the second number of transmission layers using the type 2 layer mapping scheme is any value from zero to six.

3. The method according to claim 1, wherein the capability information is configured to indicate:
support for enabling a type 2 layer mapping scheme for transmission of five layers to eight layers, wherein the transmission of five or more layers supports the two codewords;
support for enabling a type 2 layer mapping scheme for transmission of four or more layers, wherein the transmission of four or more layers supports the two codewords; or
support for enabling a type 2 layer mapping scheme for transmission of two or more layers, wherein the transmission of two or more layers supports the two codewords.

4. The method according to claim 1, further comprising:
determining and enabling a target layer mapping scheme based on the capability information, wherein the target layer mapping scheme is the type 1 layer mapping scheme or the type 2 layer mapping scheme.

5. The method according to claim 4, wherein determining and enabling the target layer mapping scheme based on the capability information comprises:
determining and enabling, in a case where the capability information indicates the support for enabling the type 2 layer mapping scheme, the type 2 layer mapping scheme according to the capability information; or
determining and enabling, in a case where the capability information indicates that enablement of the type 2 layer mapping scheme is not supported, the type 1 layer mapping scheme according to the capability information.

6. The method according to claim 1, further comprising:
receiving indication information; and
determining and enabling a target layer mapping scheme based on the indication information, wherein the target layer mapping scheme is the type 1 layer mapping scheme or the type 2 layer mapping scheme.

7. The method according to claim 1, further comprising:
reporting suggestion information in a case where a triggering condition is met, wherein the suggestion information is configured to suggest that a network device indicate enablement of the type 2 layer mapping scheme.

8. The method according to claim 7, wherein the triggering condition comprises at least one of:
a signal quality difference between layers is detected to be greater than a first threshold in a scenario of single-transmission reception point (TRP) transmission or multi-TRP transmission;
a channel quality indication difference between cooperating TRPs is detected to be greater than a second threshold in the scenario of the multi-TRP transmission;
a signal quality difference between a group of reporting beams measured during beam measurement is greater than a third threshold;
a consecutive retransmission event of a transport block (TB) occurs under a multi-layer transmission;
a counter configured for the consecutive retransmission event under the multi-layer transmission reaches a fourth threshold; or
a timer configured for the consecutive retransmission event under the multi-layer transmission expires.

9. (canceled)

10. The method according to claim 7, wherein the method further comprises:
receiving indication information, wherein the indication information is generated by the network device according to the suggestion information; and
determining and enabling a target layer mapping scheme based on the indication information, wherein the target layer mapping scheme is the type 1 layer mapping scheme or the type 2 layer mapping scheme; or
the method further comprises:
enabling, after a target time period elapses, starting from a point of transmitting the suggestion information, the type 2 layer mapping scheme for physical uplink shared channel (PUSCH) transmission, wherein the target time period is predefined; or the target time period is determined through reporting by the terminal.

11.-12. (canceled)

13. A method for receiving codeword-to-layer mapping, performed by a network device, comprising:
receiving capability information of a terminal, wherein the capability information is configured to determine support for enabling a type 2 layer mapping scheme; wherein
a maximum difference in a number of transmission layers after two codewords are subjected to layer mapping is different respectively for a type 1 mapping scheme and the type 2 layer mapping scheme.

14. The method according to claim 13, wherein the two codewords comprise a first codeword and a second codeword, and a first number of transmission layers corresponds to the first codeword subjected to layer mapping, and a second number of transmission layers corresponds to the second codeword subjected to layer mapping; wherein,
a difference in a number of transmission layers between the first number of transmission layers and second number of transmission layers using the type 1 layer mapping scheme is zero or one; and
the maximum difference in a number of transmission layers between the first number of transmission layers and the second number of transmission layers using the type 2 layer mapping scheme is any value from zero to six.

15. The method according to claim 13, wherein the capability information is configured to indicate:
support for enabling a type 2 layer mapping scheme for transmission of five layers to eight layers;
support for enabling a type 2 layer mapping scheme for transmission of four or more layers, wherein the transmission of four or more layers supports the two codewords; or
support for enabling a type 2 layer mapping scheme for transmission of two or more layers, wherein the transmission of two or more layers supports the two codewords.

16. The method according to claim 13, further comprising:
transmitting indication information, wherein the indication information is configured to determine and enable a target layer mapping scheme, wherein the target layer mapping scheme is the type 1 layer mapping scheme or the type 2 layer mapping scheme.

17. The method according to claim 16, further comprising:
generating the indication information according to the capability information.

18. The method according to claim 17, wherein generating the indication information according to the capability information comprises:
generating first indication information in a case where the capability information indicates the support for enabling the type 2 layer mapping scheme, wherein the first indication information is configured to indicate enablement of the type 2 layer mapping scheme; or
generating second indication information in a case where the capability information indicates that the enablement of the type 2 layer mapping scheme is not supported, wherein the second indication information is configured to indicate enablement of the type 1 layer mapping scheme.

19. The method according to claim 13, further comprising:
receiving suggestion information, wherein the suggestion information is configured to suggest that the network device indicate enablement of the type 2 layer mapping scheme.

20. (canceled)

21. The method according to claim 19, wherein the method further comprises:
generating indication information according to the suggestion information; or
the method further comprises:
enabling, after a target time period elapses, starting from a point of receiving the suggestion information, the type 2 layer mapping scheme for physical uplink shared channel (PUSCH) reception, wherein the target time period is predefined; or the target time period is determined through reporting by the terminal.

22. The method according to claim 21, wherein generating the indication information according to the suggestion information comprises:
accepting the suggestion information, and generating first indication information according to the suggestion information, wherein the first indication information is configured to indicate the enablement of the type 2 layer mapping scheme; or
rejecting the suggestion information, and generating second indication information according to the suggestion information, wherein the second indication information is configured to indicate enablement of the type 1 layer mapping scheme.

23.-26. (canceled)

27. A terminal, comprising:
a processor; and
a memory that stores at least one program; wherein
the processor is configured to execute the at least one program stored on the memory to cause the terminal to:
report capability information of the terminal, wherein the capability information is configured to determine support for enabling a type 2 layer mapping scheme, wherein
a maximum difference in a number of transmission layers after two codewords are subjected to layer mapping is different respectively for a type 1 mapping scheme and the type 2 layer mapping scheme.

28.-30. (canceled)

31. A network device, comprising:
a processor; and
a memory that stores at least one program; wherein the processor is configured to execute the at least one program stored on the memory to cause the network device to perform the method for receiving codeword-to-layer mapping according to claim 13.
